(19) United States
(12) Patent Application Publication
(10) Pub. No.: US 2007/0196677 A1
(43) Pub. Date: Aug. 23, 2007

(54) Polyester Film For Release Film

(76) Inventor: Hiroteru Okumura, Maibara-shi (JP)

Correspondence Address: NIXON & VANDERHYE, PC, 901 NORTH GLEBE ROAD, 11TH FLOOR, ARLINGTON, VA, 22203, US

(21) Appl. No.: 10/582,236

(22) PCT Filed: Nov. 24, 2004
(86) PCT No.: PCT/JP04/17377

§ 371 Date: Apr. 5, 2007

(30) Foreign Application Priority Data
Dec. 10, 2003 (JP) 2003-421895

(51) Int. Cl. B32B 27/36

(52) U.S. Cl. 428/480

(57) ABSTRACT

The present invention provides a polyester film for release film which makes it possible to conduct accurate inspections of polarizing plates by the crossed nicols method and can also inhibit transfer of the polyester oligomers into the adhesive layer.

A polyester film for release film having a coating layer on at least one surface thereof with defects of not more than 50 per m², which polyester film has such properties that the amount of polyester oligomers extracted from the surface of said coating layer after 10-minute heat treatment at 150° C. is not more than 0.3 mg/m², and the inclination of the principal axis of orientation (angle of orientation) of the film is not more than 8°; a release film for polarizing plate comprising the above-said film and a release layer provided thereon; and a polyester film for polarizing plate protective film comprising the above-said film.

### TECHNICAL FIELD

The present invention relates to a polyester film having excellent optical properties which are an essential requirement for the films used for liquid crystal displays and such. More particularly, it relates to such a polyester film which is suited for use in particular as a release film for polarizing plates or a polarizing plate protective film.

### BACKGROUND ART

With rapid dissemination of cellular phones and personnel computers in recent years, the demand has increased sharply for the liquid crystal displays (LCD) which are capable of realizing greater reduction of thickness and weight, lower power consumption and higher image quality than possible with the conventional CRT displays. The advance of techniques for the enlargement of display screen of LCD is also remarkable. As an instance of such trend toward enlargement of display screen, LCD is used recently for the large-sized monitors or TV's with a 17-in. or wider screen. Most of the wide-screen LCD's are designed to be high in brightness by elevating luminance of the backlight integrated into LCD or by incorporating a luminance-enhancing film in the liquid crystal unit.

In these high-luminance type LCD's, even the tiny luminescent spots in the display system tend to become a troublemaker, and the presence of a foreign matter of such a tiny size that would pose no problem in the conventional low-luminance type LCD's can trigger a serious problem in the component members such as polarizing plate, phase-difference plate or phase-difference polarizing plate incorporated in the display system. Thus, while efforts are needed for preventing inclusion of foreign matter in the production process, so much importance is also attached to the improvement of stable inspection capability, such as improvement of inspectability and repeat accuracy of inspection, that would allow infallible detection of inclusion of foreign matter, should it occur, as a defect.

For instance, visual inspection by the crossed nicols method is carried out for the check for defects in the polarizing plates, while inspection by an automatic alien matter inspection machine making use of the crossed nicols method is conducted for the polarizing plates used for large-sized TVs with a 30-in. or wider screen. In this crossed nicols method, a pair of polarizing plates are arranged with their principal axes of orientation crossed at right angles to each other to produce an extinct state, causing an alien matter or a defect, if any, to manifest itself as a luminescent spot. For the polarizing plates, a polyester film having a release layer formed thereon with the interposition of an adhesive layer is used, and the crossed nicols inspection is carried out with the polyester film being held between the pair of polarizing plates. Generally, however, use of a release polyester film may present an obstacle to the inspection by the crossed nicols method; it tends to make it liable to fail to detect inclusion of foreign matter or other defects. Also, in case where a foreign matter or a defect is present in the polyester film, the polarizing plate may be mistakenly judged as defective because the source of the defect can not be identified, and this may become a cause of boost of the percent defective of the products.

Further, the release film attached to the polarizing plates used for large-sized TV has the problem that the polyester oligomers existing in the polyester film may be transferred to the adhesive layer to produce a luminescent spot in the adhesive layer after lapse of a certain time.

As the biaxially oriented polyester films used for release films, there have been disclosed the following types: those in which the amount of the low-molecular weight materials extracted from the film surface is controlled (see, for instance, Patent Document 1) and those in which the angle of orientation of the film is specified (see, for instance, Patent Document 2), but even when these films are used, there still exist the problems in carrying out the inspections for infallibly detecting the defects. It has been also proposed to reduce the amount of polyester oligomers extracted from the film surface by providing a coating on the film (see, for instance, Patent Document 3), but little notice has ever been given to the presence of minute coating defects in the film surface and concomitant local precipitation of the polyester oligomers.
Patent Document 1: Japanese Patent Application Laid-Open (KOKAI) No. 2000-141570
Patent Document 2: Japanese Patent Application Laid-Open (KOKAI) NO. 2000-335649
Patent Document 3: Japanese Patent Application Laid-Open (KOKAI) No. H12-289168

### Problem to be Solved by the Invention

The present invention is intended to solve the above problems, and for this purpose, it provides a polyester film to be used for release film which makes it possible to carry out accurate inspection of the polarizing plates by the crossed nicols method and is also capable of inhibiting transfer of the polyester oligomers to the adhesive layer.

### Means for Solving the Problem

As a result of present inventor's earnest studies for solving the above problem, it has been found that the above problem could be easily solved by providing a polyester film having a specific structure.

Thus, in an aspect of the present invention, there is provided a polyester film for release film having a coating layer on at least one surface thereof with defects of not more than 50 per m², which polyester film has such properties that the amount of polyester oligomers extracted from the surface of said coating layer after 10-minute heat treatment at 150° C. is not more than 0.3 mg/m², and the inclination of the principal axis of orientation (angle of orientation) of the film is not more than 8°.

### Effect of the Invention

According to the present invention, there is provided a polyester film for release film which makes it possible to conduct accurate inspection of polarizing plates by the crossed nicols method.

### BEST MODE FOR CARRYING OUT THE INVENTION

The present invention is described in detail below.

The term “polyester” used in the present invention refers to the polymers containing ester groups that can be obtained from polycondensation of dicarboxylic acids and diols or hydroxycarboxylic acids. Examples of the said dicarboxylic acids include terephthalic acid, succinic acid, isophthalic acid, adipic acid, azelaic acid, sebacic acid, dodecaonic diacid, 2,6-naphthalenedicarboxylic acid, and 1,4-cyclohexanedicarboxylic acid. Examples of the said diols include ethylene glycol, 1,3-propanediol, 1,6-hexanediol, 1,4-butanediol, diethylene glycol, triethylene glycol, neopentyl glycol, 1,4-cyclohexanedimethanol, and polyethylene glycol. Examples of the said hydroxycarboxylic acids include p-hydroxybenzoic acid and 6-hydroxy-2-naphthoic acid.

As typical examples of these polymers, polyethylene terephthalate, polytrimethylene terephthalate, polybutyrene terephthalate and polyethylene-2,6-naphthalate can be cited. These polymers may be homopolymers or may have a third component copolymerized therein.

The films provided according to the present invention are preferably biaxially oriented polyester films in view of their high strength and excellent dimensional stability. Although biaxially stretched films are preferably used, it is also possible to use the polyester films which are non-stretched or stretched at least in one direction, as far as they are embraced within the concept of the present invention.

It is imperative for the polyester film of the present invention that the inclination of the principal axis of orientation (angle of orientation) of the film is not more than 8 degrees. If the angle of orientation exceeds 8 degrees, the intensity of light leaking from the polarizing plate during its inspection becomes too high, hindering inspection for contaminates of the polarizing plate.

It is also an essential requirement for the film of the present invention that the amount of oligomers extracted from the coating surface of the film after 10-minute heat treatment at 150° C. is not more than 0.3 mg/m², preferably not more than 0.2 mg/m². If the amount of oligomers exceeds 0.3 mg/m², the oligomers may transfer into the adhesive layer and agglomerate to become a contaminant in the step where an adhesive layer is provided on the release film produced by using the said polyester film.

It is a further requirement for the polyester film of the present invention that the number of the defects of the coating layer on the polyester film surface is not more than 50, preferably not more than 20, more preferably not more than 10, per m² of the film surface. If the number of defects of the coating layer exceeds the above-defined range, there may take place concentrated precipitation of polyester oligomers from the defective portions to cause transfer of oligomers to the adhesive layer.

It is also preferable that heat shrinkage on 30-minutes heating at 150° C. is not more than 5%, and that the film strength (F5) at 5% elongation is not less than 100 MPa. If these factors are outside the above-defined ranges, flatness of the film may be spoiled in the release layer coating and drying step or in the step of applying a adhesive on the release film, causing non-uniformity in adhesive thickness on the release film and consequently producing a defective polarizing plate.

Further, the number of foreign materials with a maximum diameter of 150 μm or more, that is allowed to exist in the film, is preferably 0 per m², and the number of foreign materials with a maximum size of 30 μm or more is preferably 1.5 or less per m². If the number of foreign materials with a maximum diameter of 150 μm or more is not 0 per m² or the number of foreign materials with a maximum diameter of 30 μm or more is more than 1.5 per m², the foreign materials in the polyester film may become luminescent spots and the polarizing plate itself may be judged defective because the source of defect is in many cases unidentifiable.

As regards film haze, it is preferably not more than 6%. Otherwise, the luminescent spots in the defective area may become hard to detect.

Further, the number of scratches with a width of 10 μm or more in the film surface is preferably not more than 20, preferably not more than 10 per m² of the film surface. If the number of scratches with a width of 10 μm or more is more than 20 per m², the scratches portions in the film surface may become the luminescent spots during the crossed nicols inspection, or in the case of visual appearance inspection of a polarizing plate by use of reflected light, the scratches portions may be judged as luminescent spots and the polarizing plate, which is actually effective, may be deemed defective.

Also, the b value determined by making use of transmitted light by a color-difference meter should preferably be in the range of −2.0 to 2.0. If the b value is outside the above-defined range, the color tone at the edge of a roll of release film having a release layer provided on a polyester film may become excessively yellowish or bluish to give rise to the practical problems.

In the polyester film of the present invention, preferably a filler is incorporated to improve slip characteristics of the film for bettering its workability. The fillers that can be incorporated in the film include the inorganic particles such as particles of silica, calcium carbonate, kaolin, titanium oxide, aluminum oxide, barium sulfate and zeolite, and the organic particles such as particles of silicone resins, crosslinked polystyrenes and acrylic resins. These particulate materials may be contained in the film either singly or as a mixture of two or more types. The average size of the particles used, the amount of the particles incorporated and the particle size distribution are not specifically defined as far as they don't affect the effect of the invention, but preferably the average particle size (diameter) is in the range of 0.1 to 4.0 μm and the amount of particles incorporated is in the range of 0.01 to 3.0% by weight.

Of these fillers, the calcium carbonate particles are, in some cases, preferably incorporated in an amount of not less than 0.03% by weight based on the polyester because this allows obtainment of a polyester film with few foreign materials.

The polyester film of the present invention may be either a single-layer film or a multi-layer film provided that the effect of the present invention is maintained, but a film of a multi-layer structure, such as 2-type and 2-layer structure, 2-type and 3-layer structure or 3-type and 3-layer structure, is preferred.

The present invention is further illustrated below with regard to the film production process, but the present invention is not limited to the embodiments shown below but various changes and modifications can be made without departing from the scope and spirit of the present invention.

The polyester chips dried by a conventional method are supplied to a melt extruder and melted by heating to a temperature above the melting points of the respective polymers used. Then the molten polymers are extruded through dies onto a rotating cooling drum whereby the melt is quickly cooled down to a temperature below the glass transition temperature and thereby solidified, forming a non-oriented sheet of a substantially amorphous state. In this operation, in order to better flatness of the sheet, it is preferable to elevate adhesion between the sheet and the rotating cooling drum. In the present invention, an electrostatic pinning method and/or a liquid coating adhesion method are used for the above purpose.

In the present invention, the thus obtained sheet is preferably stretched in two axial directions to form a film. As for the stretching conditions, the non-stretched sheet is preferably stretched 1.3 to 6 times in the longitudinal direction at 80 to 130° C. to form a monoaxially (in the longitudinal direction) stretched film, then further stretched 1.3 to 6 times in the transverse direction at 90 to 160° C., and then heat treated at 150 to 240° C. for 1 to 600 seconds. The resultant film is preferably relaxed 0.1 to 20% in the longitudinal and/or transverse directions in the highest temperature zone of heat treatment and/or in the cooling zone at the end of heat treatment.

In order to minimize the variation of angle of orientation and to maintain flatness of the film during the heat treatment, preferably the stretch ratio in the longitudinal direction is selected to be 2.6 to 3.1 times, the stretch ratio in the transverse direction is selected to be not less than 5.0 times, and the heat treatment temperature (main crystal temperature) is adjusted to be not lower than 185° C.

Further, if necessary, the film may be re-stretched in the longitudinal and transverse directions. This biaxial stretching may be either successive or simultaneous operation, but the simultaneous operation is preferred because it is capable of lessening the variation of angle of orientation. In such simultaneous biaxial stretching operation, the non-stretched sheet is stretched and oriented in both longitudinal direction (or machine direction) and transverse direction (or width direction) with the temperature controlled at usually 70 to 120° C., preferably 80 to 110° C., and the stretch ratio is 4 to 50 times, preferably 7 to 35 times, more preferably 10 to 25 times in terms of areal ratio. Then the film is heat treated at 170 to 250° C. under tension or under relaxation of not more than 30% to obtain a stretched and oriented film. The conventional stretching systems such as screw system, pantograph system and linear motor system can be used for the above biaxial stretching operation.

“Screw system” is a system in which the clips are placed in the screw channels with the clip interval being widened gradually. “Pantograph system” is a system in which the clip interval is widened by using a pantograph. “Linear motor system” applies the principle of linear motor, in which the clips are controllable individually. This system is advantageous in that the clip interval can be adjusted freely as desired. Also, simultaneous biaxial stretching can be conducted in two or more stages. In this case, stretching can be done either in a single tenter or two or more tenters may be used in combination.

The coating layer which controls the amount of polyester oligomers precipitated on the film surface is not subject to any specific restrictions as far as it is embraced within the concept of the present invention, but this layer can be obtained by containing polyvinyl alcohol in an amount of 10 to 100% by weight, preferably 20 to 90% by weight, more preferably 30 to 90% by weight.

The polyvinyl alcohol used in the present invention can be synthesized from an ordinary polymerization reaction and is preferably soluble in water. Its polymerization degree, although not specifically defined, is usually not less than 100, preferably 300 to 40,000. If the polymerization degree of the polyvinyl alcohol used is not more than 100, water resistance of the coating layer tends to lower. The saponification degree of the polyvinyl alcohol is also not specified, but usually a saponified product of polyvinyl acetate with a sapofinication degree of not less than 70 mol %, preferably 80 to 99.9 mol %, is practically used. In the coating layer, in addition to the said material, one or more types of water-soluble or water-dispersible binder resin may be contained as required. Examples of the binder resins usable here include polyesters, polyurethane, acrylic resins, vinyl resins, epoxy resins and amide resins. These resins may have substantially a composite skeletal structure formed by copolymerization or other treatments. As examples of the binder resins having such a composite structure, acrylic resin grafted polyesters, acrylic resin grafted polyurethanes, vinyl resin grafted polyesters and vinyl resin grafted polyurethanes can be mentioned.

Further, if necessary, the film may contain a crosslinking reactive compound. This compound undergoes a crosslinking reaction with the functional groups contained in the coating layer composition to improve cohesiveness, surface hardness, scratch resistance, solvent resistance and water resistance of the coating layer. Also, the coating layer of the film according to the present invention may contain additives such as surfactant, defoaming agent, coatability improver, thickener, antistatic agent, organic lubricant, organic particles, inorganic particles, antioxidant, ultraviolet absorber, foaming agent, dye and pigment. These additives may be used alone or as a mixture of two or more. For instance, it is preferable to use a defoaming agent or a surfactant for inhibiting coating defects caused by the fine air bubbles in the coating operation.

The oligomer preventive layer may be formed by either in-line coating or off-line coating, but in-line coating is preferred for the economical reason. In an in-line coating operation, the film is coated before entering the transverse stretching tenter after completion of longitudinal stretching and dried in the tenter.

The polyester film of the present invention may be provided with specific properties required in practical use of the film, such as antistatic properties or weather resistance, by in-line or off-line coating if such treatments don't adversely affect the effect of the invention.

Further, in the polyester film of the present invention, other thermoplastic resins, for instance, polyethylene naphthalate or polytrimethylene terephthalate, may be blended within limits not prejudicial to the effect of the present invention. It is also possible to mix an ultraviolet absorber, antioxidant, surfactant, pigment, fluorescent brightener and the like. Addition of an antioxidant is especially preferred.

In case where a release layer is provided on the polyester film of the present invention, the material to be used for such a release layer is not specifically defined as far as it meets the requirement of proper releasability. It may be of the type comprising a curable silicone resin as the major component or a modified silicone type obtained from graft polymerization with an organic resin such as urethane resin, epoxy resin or alkyd resin. Of these materials, the one comprising a curable silicone resin as major component is preferred for the reason of good releasability.

The curable silicone resin used in the present invention may be of any of the curing reaction types such as solvent addition type, solvent condensation type, solvent UV curing type, no-solvent addition type, no-solvent condensation type, no-solvent UV curing type and no-solvent electron ray curing type.

### EXAMPLES

The present invention is described in further detail below with reference to the examples thereof. The present invention, however, is not limited to the following examples but can be embodied otherwise as well without departing from the scope and spirit of the invention. The various properties and characteristics of the polyester film according to the present invention were determined or defined as explained below.

(1) Angle of orientation:

6 cm square samples were prepared by cutting the polyester film in the width direction from an edge thereof, cutting being made from three positions along the length of the film corresponding to 10%, 50% and 90%, respectively, of the film width. The angle of orientation at 7 spots of the film was measured by an automatic birefringence analyzer (KOBRA-21ADH mfd. by Oji Scientific Instruments), and the greatest value of the measurements was determined as the angle of orientation of the film. Then the similar samples were obtained by cutting the film in the longitudinal direction at three positions, and the angle of orientation was determined in the same way. In case where the film is in a rolled up state, there is no need of making measurement along the full length of the film in the longitudinal direction; it suffices to cut out a 2 m long piece from the film and then cut out the samples from the 2 m long piece at three positions in the longitudinal direction.

(2) Amount of surface oligomers:

The polyester film was cut to a size of 25 cm square and heat treated in a 150° C. oven (hot-air circulating oven mfd. by Tabai Seisakusho Co., Ltd.) for 10 minutes, and this heat treated polyester film was folded into a square box which was open at the top and had a bottom area of 250 cm². The coating layer, when provided, was formed so that it would come on the inside. 10 ml of DMF was put into the box, and after 3-minute standing, DMF was recovered. The recovered DMF was supplied to a liquid chromatograph (SHIMAZU LC-7A) to determine the amount of oligomers in DMF, and the obtained value was divided by the DMF-contacted film area to decide the amount of film surface oligomers (mg/m²). The amount of oligomers in DMF was determined from the peak areal ratio between the standard sample and the measured sample (absolute calibration method). The standard sample was prepared by accurately weighing the previously dispensed out oligomer (cyclic trimer) and dissolving it in the accurately weighed DMF. The standard sample concentration is preferably in the range of 0.001 to 0.01 mg/ml. The liquid chromatograph was operated under the following conditions.
Mobile phase A: acetonitrile
Mobile phase B: 2% acetic acid solution
Column: Mitsubishi Chemical Corporation MCI GEL ODS 1HU
Column temperature: 40° C.
Flow rate: 1 ml/min
Detection wavelength: 254 nm
   (3) Number of coating defects:

3-wavelength-region emitted day-white light with a color temperature of 7100K was passed into the coating layer on the film surface at an incidence angle of 45°, and the coating defects were visually detected from the position of 45° reflection. This defect inspection was conducted over the area of 10 m², and the number of coating defects in this area was calculated.

(4) White spot inspection:

The film was cut into a 50 cm square piece and heat treated in a 150° C. oven (hot-air circulating oven mfd. by Tabai Seisakusho Co., Ltd.) for 10 minutes, and then the film was checked for the white spots (defects) on its surface by an optical microscope. Rating was made as follows based on the size and number of the white spots.
⊚⊚>⊚>◯>Δ>X>X X
(→fewer white spots) (more white spots→)
(5) Heat shrinkage:

The film was cut into 15 mm×150 mm strips from the positions corresponding to 10%, 50% and 90% of the film width in the width direction of the film, and the strips were heat treated in a 150° C. oven (hot-air circulating oven mfd. by Tabai MFG Co., Ltd.) in a tensionless state for 30 minutes. Thereafter, the lengths of each strip film before and after the heat treatment were measured, determining the heat shrinkage rate from the following equation.
Heat shrinkage rate (%)=[(a−b)/a]×100
(a: film length (mm) before heat treatment;
b: film length (mm) after heat treatment)
(6) F5:

The film was cut into 50 mm×15 mm strips from the same positions as in the above-described determination of heat shrinkage rate, and by using a tension tester Intesco Model 2001 (mfd. by Intesco Co., Ltd.), each of the film strips was pulled at a rate of 50 mm/min in a chamber adjusted to 23° C. and 50% RH. The strength at 5% elongation was determined as F5 value.

(7) Number of foreign materials:

The 700 mm×10 m polyester film (area: 7 m²) was subjected to visual inspection for foreign materials according to the crossed nicols method, and the sizes of all of the detected foreign materials were measured by an optical microscope. The number of the foreign materials with a size of 150 μm or more in major axis and the number of those with a size of 30 μm or more were counted, the obtained values being reduced to the counts per unit area. In the following Examples, the foreign material inspection was conducted with the large-sized samples, but it is also possible to conduct the similar foreign material inspection with the small-sized samples, such as A4 size samples, in the same way as described above.

(8) Film haze:

Film haze was measured according to JIS-K6714 using an integrating sphere type turbidimeter NDH-20D (mfd. by Nippon Denshoku Kogyo KK).

(9) Number of scratches:

Light from a halogen lamp was applied to the 1,500 mm×10 m film surface (area: 15 m²) to make visual observation of the film surface. The number of the scratches which presented themselves as luminescent spots was counted while measuring the width of all of the scratches by an optical microscope, and the number of the scratches with a width of 10 μm or greater was calculated. Although the number of scratches with a width of 10 μm or greater was counted using the large-sized samples in the Examples, it is possible to make similar measurements with smaller-sized films, such as A4 size films, in the same way as described above.

(10) b value:

The b value was determined by the transmission method according to JIS Z-8722 using a spectral color-difference meter SE-2000 (mfd. by Nippon Denshoku Kogyo Industries Co., Ltd.).

(11) Visual inspectability under crossed nicols:

A release agent comprising 100 parts of a curable silicone resin (KS-779H produced by Shin-Etsu Chemical Co., Ltd.), 1 part of a curing agent (CAT-PL-8 produced by Shin-Etsu Chemical Co., Ltd.) and 2,200 parts of a methyl ethyl ketone (MEK)/toluene mixed solvent was coated on the polyester film to a coating thickness of 0.1 g/mm² and dried at 170° C. for 10 seconds to obtain a release film. This release film was attached tightly to a polarizing film with the interposition of an adhesive so that the width direction of the release film would become parallel to the axis of orientation of the polarizing film to make a polarizing plate. The polarizing plate for inspection was placed on the release film so that the axis of orientation would become vertical to the width direction of the film. By applying white light via the polarizing plate, visual observation was made by 10 inspectors from the polarizing plate for inspection, and visual inspectability under crossed nicols was evaluated according to the following formula. For the measurements, the A4 size samples were cut out from an edge of the obtained polyester film in its width direction, cutting being made from the positions corresponding to 10%, 50% and 90% of the film width.

<Rating Formula for Visual Inspectability Under Crossed Nicols>
⊚>◯>Δ>X >XX
(→better inspectability) (worse inspectability→)

In the above rating, the samples with inspectability of Δ or better are of the level of quality acceptable for practical use without problem.

(12) Foreign material recognizability:

A release agent comprising 100 parts of a curable silicone resin KS-779H (produced by Shin-Etsu Chemical Co., Ltd.), 1 part of a curing agent CAT-PL-8 (produced by Shin-Etsu Chemical Co., Ltd.) and 2,200 parts of a methyl ethyl ketone (MEK)/toluene mixed solvent was applied on one side of the polyester film to a coating thickness of 0.1 g/mm² and dried at 170° C. for 10 seconds to obtain a release film. This release film was attached tightly to a polarizing film with the interposition of a known acrylic adhesive so that the width direction of the release film would become parallel to the axis of orientation of the polarizing film to make a polarizing plate. Here, black metal powders (foreign material) having a size of 50 μm or greater were mixed at a rate of 50 particles/m² between the adhesive and the polarizing film. The polarizing plate for inspection was placed on the thus obtained foreign material-mixed polarizing plate release film so that the axis of orientation would become vertical to the width direction of the release film. White light was applied via the polarizing plate, and visual observation by 10 inspectors was conducted from the polarizing plate for inspection to determine whether it was possible or not to recognize the foreign material mixed between the adhesive and the polarizing film, the results being evaluated according to the following rating formula. Evaluation was made at three parts, viz. the central part and both ends, of the obtained film, and the result obtained at the part where visual inspectability was best was here designated as foreign material recognizability of the film.

<Foreign Material Recognizability Rating Formula>
⊚>◯>Δ>X
(→better recognizability) (worse recognizability→)

In the above rating, the samples with recognizability of Δ or better are of the level of quality acceptable for practical use without problem.

The materials used in the following Examples were obtained in the manner described below.

(Production of Polyester Chips)

100 parts of dimethyl terephthalate, 70 parts of ethylene glycol and 0.07 parts of calcium acetate monohydrate were supplied to a reactor and heated while distilling off methanol to carry out an ester exchange reaction. The temperature was raised to 230° C. in approximately 4.5 hours after start of the reaction, at which point the ester exchange reaction was substantially completed. Then 0.04 parts of phosphoric acid and 0.035 parts of antimony trioxide were added and the mixture was polymerized by a conventional method. The reaction temperature was raised gradually till finally reaching 280° C. while the pressure was reduced gradually to finally reach 0.05 mmHg. 4 hours later, the reaction was finished and the reaction product was made into chips by a conventional method to obtain a polyester A having an intrinsic viscosity of 0.65.

In the above production process of polyester A, 10,000 ppm of calcium carbonate having an average primary particle diameter of 0.7 μm was added to obtain polyester B.

In the above polyester A production process, 8,000 ppm of amorphous silica having an average primary particle diameter of 2.4 μm was added to obtain polyester C.

Also in the above polyester A production process, 20,000 ppm of δ type aluminum oxide having an average primary particle diameter of 60 nm was added to obtain polyester D.

### Example 1

(Production of Polyester Film)

The said polyesters A-D were mixed in the ratios shown in Table 1 to provide two types of mixed materials for forming layer A and layer B, and these two types of materials were supplied to two sets of double-screw extruders respectively. After melted at 285° C., the materials were co-extruded onto a 20° C. casting drum as a two-type and 3-layer structure designed to form a film having a layer thickness profile of layer A/layer B/layer A=10%/80%/10% with the layers A forming the outermost layers (surface layers) and the B layer forming the intermediate layer, and thereby cooled and solidified to obtain a non-oriented sheet. This sheet was stretched 2.8 times in the machine direction at 100° C., then a water-dispersed coating solution A adjusted to a solid concentration of 2.5% as shown below was applied on the sheet to a coating thickness of 0.05 μm after stretching and drying, and after passing through the preheating step in a tenter, the sheet was stretched 5.4 times transversely at 120° C., then heat treated at 200° C. for 10 seconds and thereafter relaxed 10% in the width direction at 180° C. to obtain a 3,000 mm wide and 40 μm thick polyester film. The obtained polyester film had excellent visual inspectability and foreign material recognizability and was of high practicability.

(Water-Dispersed Coating Solution A)

An aqueous coating solution having a composition of Shallol DC-303P (Daiichi Kogyo Seiyaku Co., Ltd.)/polyvinyl alcohol (saponification degree: 88%; polymerization degree: 500)/silica sol (average particle diameter: 0.05 μm)/Surfynol 420 (Air Products & Chemicals)=84/10/5 in weight ratio calculated as solid.

(Water-Dispersed Coating Solution B)

An aqueous coating solution having a composition of Shallol DC-303P (Daiichi Kogyo Seiyaku Co., Ltd.)/polyvinyl alcohol (saponification degree: 88%; polymerization degree: 500)/silica sol (average particle diameter: 0.05 μm)=75/10/15 in weight ratio calculated as solid.

### Example 2

A polyester film was produced in the same way as in Example 1 except that the composition and the film forming conditions were changed as shown in Table 1, and that the water-dispersed coating solution A adjusted to a solid concentration of 3% by weight was used. The obtained polyester film had the properties shown in Table 1 and was suited for practical use.

### Example 3

A polyester film was produced in the same way as in Example 1 except that the composition and the film forming conditions were changed as shown in Table 1, and that the water-dispersed coating solution A adjusted to a solid concentration of 1% by weight was used. The obtained polyester film had the properties shown in Table 1 and was suited for practical use.

### Example 4

A 60 μm thick polyester film was obtained in the same way as in Example 1 except that the composition and the film forming conditions were changed as shown in Table 1, and that the water-dispersed coating solution B adjusted to a solid concentration of 3% by weight was used. The obtained polyester film had the properties shown in Table 1 and was suited for practical use.

### Comparative Example 1

A polyester film was produced in the same way as in Example 1 except that the composition and the film forming conditions were changed as shown in Table 2, and that the water-dispersed coating solution B adjusted to a solid concentration of 1% by weight was used. The obtained polyester film lacked practicability as it had white spots and was bad in visual inspectability and foreign material recognizability.

### Comparative Examples 2-4

Polyester films were produced in the same way as in Example 1 except that the composition and the film forming conditions were changed as shown in Table 2, and that no water-dispersed coating solution was applied. The obtained polyester films lacked practicability because of the presence of white spots and bad visual inspectability and foreign material recognizability.

TABLE 1

| | | Example No. | | | |
|---|---|---|---|---|---|
| | | 1 | 2 | 3 | 4 |
| Layer A | Polyester A | 50 | 60 | 60 | 35 |
| composition (wt %) | Polyester B | 40 | 30 | 30 | 45 |
| | Polyester C | — | — | — | — |
| | Polyester D | 10 | 10 | 10 | 20 |
| Layer B | Polyester A | 100 | 100 | 100 | 100 |
| composition (wt %) | Polyester D | — | — | — | — |
| Film thickness (μm) | | 40 | 40 | 40 | 60 |
| Longitudinal stretch ratio | | 2.8 | 2.8 | 2.7 | 3.0 |
| Longitudinal stretching temperature (° C.) | | 100 | 100 | 100 | 105 |
| Transverse stretch ratio | | 5.5 | 5.6 | 5.4 | 5.2 |
| Transverse stretching temperature (° C.) | | 110 | 110 | 110 | 100 |
| Heatset temperature (° C.) | | 200 | 185 | 185 | 200 |
| Angle of orientation (degrees) | | 4.5 | 3.9 | 3.7 | 7.2 |
| Amount of surface oligomers (mg/m²) | | 0.10 | 0.12 | 0.20 | 0.26 |
| Number of coating defects (per m²) | | 1 | 5 | 15 | 40 |
| Shrinkage | Longitudinal | 2.4 | 4.7 | 4.6 | 2.6 |
| Longitudinal | direction (%) | | | | |
| direction | Width direction | 1.7 | 3.6 | 3.4 | 1.6 |
| | (%) | | | | |
| F5 value | Longitudinal | 105 | 103 | 100 | 107 |
| | direction (MPa) | | | | |
| | Width direction | 129 | 132 | 129 | 125 |
| | (MPa) | | | | |
| Number of | 150 μm or more | 0.0 | 0.0 | 0.0 | 0.0 |
| foreign | (per m²) | | | | |
| materials | 30 μm or more | 0.7 | 1.3 | 1.0 | 1.4 |
| | (per m²) | | | | |

| | | | | |
|---|---|---|---|---|
| Film haze (%) | 3.5 | 2.8 | 2.8 | 4.5 |
| Number of scratches (per m²) | 2 | 13 | 10 | 5 |
| b value | 0.6 | 0.8 | 0.7 | 1.2 |
| White spots | ⊚⊚ | ⊚ | ◯ | Δ |
| Visual inspectability | ⊚ | ⊚ | ⊚ | ◯ |
| Foreign material recognizability | ⊚ | ◯ | ⊚ | ◯ |

TABLE 2

| | | Comparative Example No. | | | |
|---|---|---|---|---|---|
| | | 1 | 2 | 3 | 4 |
| Layer A | Polyester A | 20 | 30 | 58 | 30 |
| composition (wt %) | Polyester B | — | — | 2 | — |
| | Polyester C | 40 | 30 | — | 70 |
| | Polyester D | 40 | 40 | 40 | — |
| Layer B | Polyester A | 100 | 100 | 100 | 40 |
| composition (wt %) | Polyester D | — | — | — | 60 |
| Film thickness (μm) | | 40 | 40 | 40 | 40 |
| Longitudinal stretch ratio | | 3.4 | 3.1 | 2.5 | 3.1 |
| Longitudinal stretching temperature | | 100 | 100 | 100 | 100 |
| (° C.) | | | | | |
| Transverse stretch ratio | | 4.2 | 4.5 | 4.5 | 4.5 |
| Transverse stretching temperature | | 130 | 130 | 130 | 130 |
| (° C.) | | | | | |
| Heatset temperature (° C.) | | 230 | 220 | 220 | 170 |
| Angle of orientation (degrees) | | 13.5 | 10.2 | 5.8 | 7.5 |
| Amount of surface oligomers (mg/m²) | | 0.28 | 2.0 | 2.0 | 2.0 |
| Number of coating defects (per m²) | | 80 | — | — | — |
| Shrinkage | Longitudinal | 1.0 | 1.2 | 1.2 | 8.2 |
| Longitudinal | direction (%) | | | | |
| direction | Width direction | 0.1 | 0.3 | 0.3 | 5.7 |
| | (%) | | | | |
| F5 value | Longitudinal | 113 | 108 | 95 | 108 |
| | direction (MPa) | | | | |
| | Width direction | 115 | 117 | 117 | 117 |
| | (MPa) | | | | |
| Number of | 150 μm or more | 1.1 | 0.4 | 0.4 | 0.4 |
| foreign | (per m²) | | | | |
| materials | 30 μm or more | 17.9 | 6.4 | 0.4 | 18.8 |
| | (per m²) | | | | |

| | | | | |
|---|---|---|---|---|
| Film haze (%) | 4.2 | 3.5 | 2.3 | 8.0 |
| Number of scratches (per m²) | 8 | 7 | 43 | 5 |
| b value | 2.5 | 2.3 | 2.3 | 0.8 |
| White spots | X | XX | XX | XX |
| Visual inspectability | X | X | X | X |
| Foreign material recognizability | Δ | Δ | X | X |

What is claimed is:

1. A polyester film for release film having a coating layer on at least one surface thereof with defects of not more than 50 per m², which polyester film has such properties that the amount of polyester oligomers extracted from the surface of said coating layer after 10-minute heat treatment at 150° C. is not more than 0.3 mg/M², and the inclination of the principal axis of orientation (angle of orientation) of the film is not more than 8°.

2. A release film for polarizing plate comprising the polyester film as defined in claim 1 and a release layer provided thereon.

3. A polyester film for polarizing plate protective film comprising the film as defined in claim 1.
